(19) United States
(12) Patent Application Publication
(10) Pub. No.: US 2025/0319738 A1
(43) Pub. Date: Oct. 16, 2025

(54) COOLER PACKAGE ARRANGEMENT HAVING A PLURALITY OF HEAT EXCHANGERS FOR A MOTOR VEHICLE, AND MOTOR VEHICLE HAVING COOLER PACKAGE ARRANGEMENT

(71) Applicant: AUDI AG, Ingolstadt (DE)

(72) Inventors: Dejanira JUAREZ GARCIA, Ingolstadt (DE); Christian REBINGER, München (DE); Dirk SCHROEDER, Manching (DE)

(73) Assignee: AUDI AG, Ingolstadt (DE)

(21) Appl. No.: 18/868,967

(22) PCT Filed: Apr. 24, 2023
(86) PCT No.: PCT/EP2023/060567

§ 371 Date: Nov. 25, 2024

(30) Foreign Application Priority Data
Jun. 1, 2022 (DE) 102022113829.1

(51) Int. Cl. B60H 1/00

(52) U.S. Cl. CPC B60H 1/00328; B60H 1/004

(57) ABSTRACT

A cooler arrangement for a motor vehicle powered by an internal combustion engine or at least partially electrically, with a first heat exchanger which is fluidically connected to a coolant circuit of the motor vehicle; a second heat exchanger which is fluidically connected to a refrigerant circuit of the motor vehicle; a third heat exchanger which is fluidically connected to the refrigerant circuit of the motor vehicle and with an air supply device which is designed to supply air, in particular ambient air, to the first heat exchanger, to the second heat exchanger and to the third heat exchanger. The second heat exchanger and the third heat exchanger are arranged in series with one another with respect to a main flow direction of air present in the air supply device.

### FIELD

The invention relates to a cooler package arrangement for a motor vehicle powered by an internal combustion engine or at least partially electrically, with a first heat exchanger which is fluidically connected to a coolant circuit of the motor vehicle, and with a second heat exchanger which is fluidically connected to a coolant circuit of the motor vehicle.

### BACKGROUND

It is known from the prior art to use and arrange multiple heat exchangers in a motor vehicle.

As an example, reference is made to DE 10 2015 015 125 A1, in which three heat exchangers, all of which are in fluid connection with the same refrigerant circuit, are arranged one after the other with respect to an air flow direction.

An arrangement of various heat exchangers of different cooling fluid circuits for a fuel cell motor vehicle is known from DE 10 2016 119 440 A1.

From DE 196 44 583 A1 an air conditioning device with multiple heat exchangers for a motor vehicle is known.

In today's motor vehicles, heat exchangers are arranged or housed in a so-called cooler package. To date, such cooler packages, in particular for electrically powered motor vehicles, have been designed with two heat exchangers, in particular a first heat exchanger which is fluidically connected to a coolant circuit (in particular for cooling an electric drive and/or power electronics, but also for battery cooling (passive)) of the motor vehicle, and with a second heat exchanger which is fluidically connected to a coolant circuit (in particular for air conditioning, but also for battery cooling (active)) of the motor vehicle. The two heat exchangers are usually arranged in such a way that they essentially overlap or cover each other over their entire surface.

Particularly in electrically powered vehicles, the requirement for cooling capacity has increased due to the possibility of rapid charging. Furthermore, refrigeration systems, especially those with a supercritical refrigerant, are highly temperature-sensitive, wherein insufficient cooling of the refrigerant in a heat exchanger operating as a gas cooler/condenser is detrimental to the refrigeration capacity, but also to the efficiency of the refrigeration system. It must also be taken into account that, depending on the design of the refrigeration system or the cooler package with heat exchangers arranged in series on the air side, performance or efficiency deficits in the refrigeration system can occur, which can also affect passenger comfort and range.

### SUMMARY

The object of the invention is to provide a cooler package arrangement in which the above disadvantages can be reduced or avoided.

This object is achieved by a cooler package arrangement and a motor vehicle.

What is therefore proposed is a cooler package arrangement for a motor vehicle powered by an internal combustion engine or at least partially electrically, with a first heat exchanger that is fluidically connected to a coolant circuit of the motor vehicle, a second heat exchanger that is fluidically connected to a refrigerant circuit of the motor vehicle, a third heat exchanger that is fluidically connected to the refrigerant circuit of the motor vehicle, and an air supply device that is designed to supply air, in particular ambient air, to the first heat exchanger, to the second heat exchanger and to the third heat exchanger, wherein the second heat exchanger and the third heat exchanger are arranged in series with one another with respect to a main flow direction of air present in the air supply device.

By means of the second and third heat exchangers, through which the refrigerant of the refrigerant circuit or a refrigeration system flows, sufficient cooling of the refrigerant in the refrigerant circuit can be achieved so that performance or efficiency deficits can be avoided. If the second and third heat exchangers are flowed through serially on the refrigerant side, the third heat exchanger is supplied with refrigerant first and then the second heat exchanger downstream.

Alternatively, parallel flow through the second and third heat exchangers is also conceivable.

In the cooler package arrangement, the first heat exchanger can be arranged in series with at least one of the other two heat exchangers with respect to the main flow direction of air. In other words, the first heat exchanger connected to the coolant circuit can be arranged before, between or after the other two heat exchangers connected to the refrigerant circuit. An arrangement is also conceivable in which the first heat exchanger and, for example, the second heat exchanger are supplied with air in parallel with respect to the main flow direction of air, wherein, for example, the third heat exchanger is arranged in series with (in particular behind) the first and the second heat exchanger.

In the cooler package arrangement, the first heat exchanger can be a low-temperature cooler and the second heat exchanger and the third heat exchanger can be designed as a refrigerant condenser and a gas cooler, respectively. The third heat exchanger can also be referred to as the first gas cooler or condenser and the second heat exchanger can also be referred to as the second gas cooler or condenser. The third heat exchanger (first gas cooler/condenser) and the second heat exchanger (second gas cooler/condenser) are integrated into the refrigerant circuit in such a way that desuperheating or pre-cooling of the refrigerant is achieved in the third heat exchanger (first gas cooler/condenser) and a final stage of cooling of the refrigerant is achieved in the second heat exchanger (second gas cooler/condenser).

In the cooler package arrangement, the order of the heat exchangers in relation to the main flow direction of air can be as follows:
first heat exchanger before second heat exchanger before third heat exchanger (configuration I); or
second heat exchanger before first heat exchanger before third heat exchanger (configuration II); or
second heat exchanger before third heat exchanger before first heat exchanger (configuration III).

The (first) configuration I in particular forms an optimal arrangement for the cooling of the coolant circuit (water circuit). The (second) configuration II in particular represents an optimal arrangement for cooling the refrigerant circuit. The (third) configuration III in particular represents a kind of compromise for the cooling of the coolant circuit and the refrigerant circuit.

In the cooler package arrangement, each heat exchanger can have a base surface facing the main flow direction of air, wherein the base surfaces of all heat exchangers are essentially the same size; or each heat exchanger has a base surface that differs from at least one base surface of one of the other heat exchangers.

By selecting different sizes or base surfaces of the heat exchangers, the cooling performance for the respective coolant or refrigerant circuit can be influenced.

In the cooler package arrangement, with respect to the main flow direction of air, the last heat exchanger can have the largest base surface, which is in particular larger than at least one base surface of one of the heat exchangers arranged upstream thereof. Such a configuration takes into account the fact that at the rearmost or last heat exchanger with respect to the main flow direction of air, air is already present at a temperature that is higher than the ambient temperature due to the previous passage through the other heat exchangers.

In the cooler package arrangement, each heat exchanger can be designed such that it is formed with at least one coolant inflow or refrigerant inflow, in particular is formed with multiple inflows and with a respective outlet flow.

Preferably, multiple inflows for the coolant or refrigerant, which can also be referred to as internal fluid deflections, are provided in each heat exchanger.

In the cooler package arrangement, with respect to the main flow direction of air, at least the last heat exchanger can have an outlet flow that is freely exposed to air flow. This allows the coolant or refrigerant circulating in the last heat exchanger in question to be sufficiently cooled in the region of the outlet flow despite its location behind the other two heat exchangers. An appropriate structural design of the heat exchangers can also ensure that in addition to the last, the penultimate or middle heat exchanger can have a final inflow that is freely exposed to ambient air.

In the cooling package arrangement, two heat exchangers which at least partially overlap and are arranged one after the other with respect to the main flow direction of air can be arranged in such a way that their respective outlet flow essentially overlaps. This also has a positive influence on the overall cooling capacity of the refrigerant circuit or the coolant circuit.

In the cooler package arrangement, the second heat exchanger and the third heat exchanger, both of which are in fluid communication with the refrigerant circuit, can be arranged such that one of the two heat exchangers forms the frontmost heat exchanger, which is essentially fully exposed to air, and the other of the two heat exchangers is essentially, namely completely or partially, overlapped by the frontmost heat exchanger.

A motor vehicle with an internal combustion engine drive or at least partially electric drive can be designed with a cooler package arrangement as described above. The motor vehicle can in particular be a fully electrically powered motor vehicle, which can also be referred to as a battery electric vehicle (BEV).

In the motor vehicle, the first heat exchanger (low-temperature cooler) can in particular be connected to the coolant circuit which cools the electric drive and/or storage devices of the motor vehicle.

In the motor vehicle, the second and third heat exchangers (gas cooler and condenser, respectively) can be connected to the refrigerant circuit provided for vehicle air conditioning. Such a refrigerant circuit can be designed with or without a heat pump function.

It is also conceivable to arrange at least one further heat exchanger in the motor vehicle, which is connected to the coolant circuit and the refrigerant circuit for the purpose of heat transfer between the refrigerant circuit and the coolant circuit, for example designed as a so-called chiller.

### BRIEF DESCRIPTION OF THE FIGURES

Further advantages and details of the invention result from the following description of embodiments with reference to the figures. In particular:

FIG. 1 shows, in the partial figures A) to E), a simplified and schematic embodiment of a cooler package arrangement with various sub-variants;

FIG. 2 shows, in the partial figures A) to D), a simplified and schematic further embodiment of a cooler package arrangement with various sub-variants;

FIG. 3 shows, in the partial figures A) to E), a simplified and schematic embodiment of a cooler package arrangement with various sub-variants.

### DETAILED DESCRIPTION

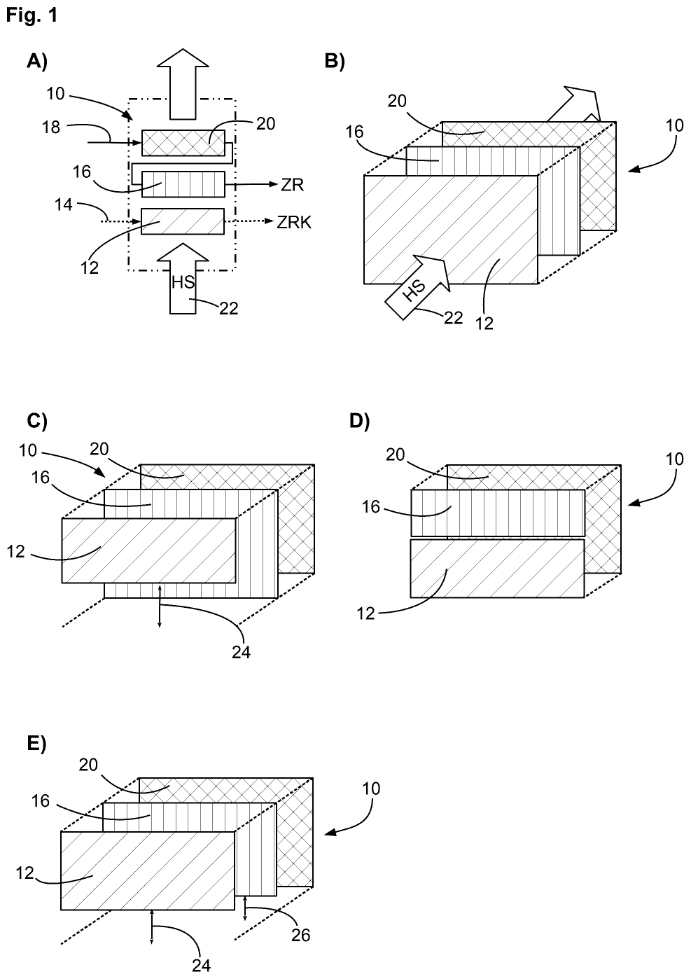

FIG. 1A shows a schematic and simplified representation of a cooler package arrangement 10 for a motor vehicle powered by an internal combustion engine or at least partially electrically, which is not shown. The cooler package arrangement comprises a first heat exchanger 12, which is fluidically connected to a coolant circuit 14 of the motor vehicle. Furthermore, the cooler package arrangement 10 has a second heat exchanger 16, which is fluidically connected to a refrigerant circuit 18 of the motor vehicle. The cooler package arrangement 10 comprises a third heat exchanger 20, which is also fluidically connected to the refrigerant circuit 18 of the motor vehicle.

Such cooler package arrangements may also comprise at least one cooler fan for sucking in or pushing an ambient air flow through the heat exchanger package. Additional heat exchangers can also be components of a cooler package arrangement. For reasons of clarity, their presentation has been omitted.

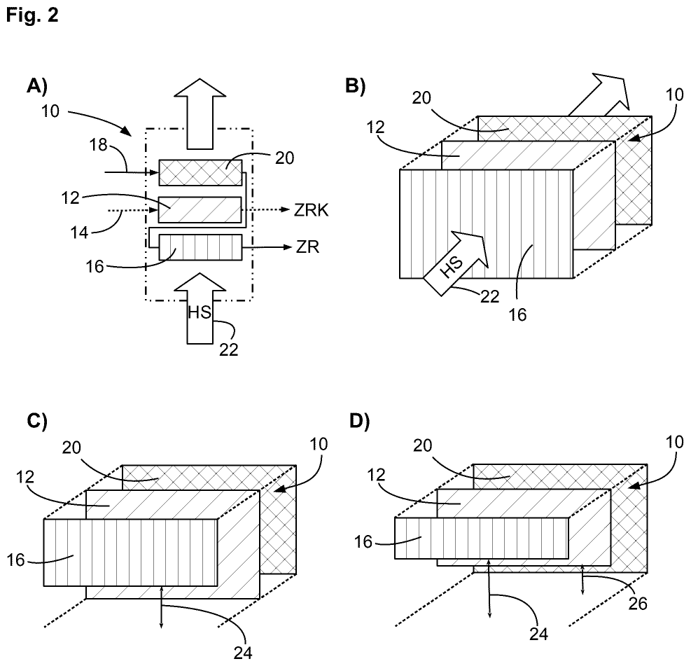

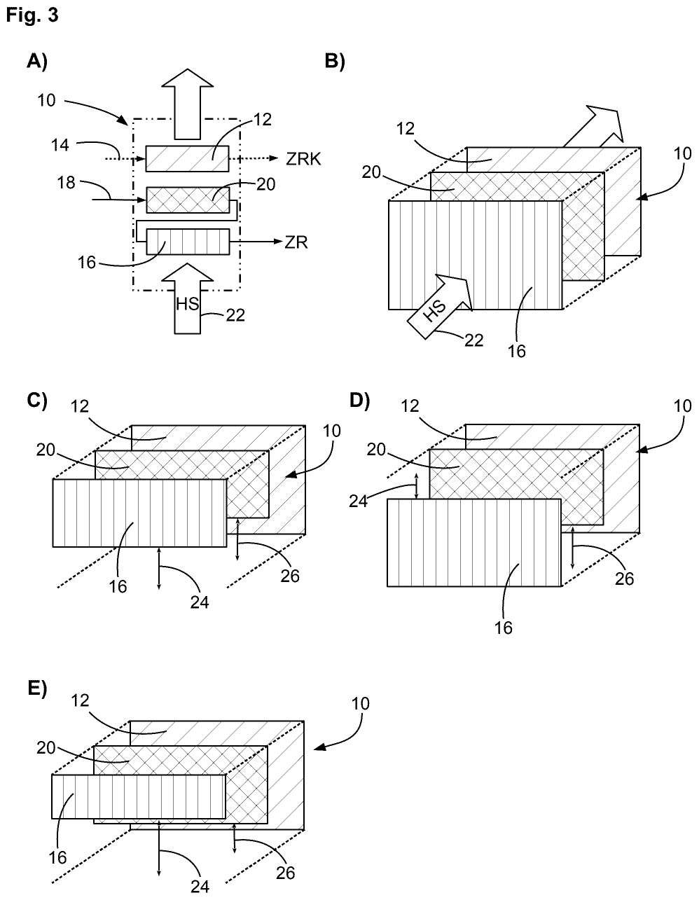

The heat exchangers 12, 16, 20 shown in FIGS. 1 to 3 each have their own hatching, which is retained in all examples of the figures. In other words, the first heat exchanger 12 is hatched diagonally, the second heat exchanger 16 is always hatched vertically and the third heat exchanger 29 is always hatched crosswise. It is pointed out that the designations first, second and third heat exchanger merely serve to be able to designate the individual heat exchangers consistently, wherein this does not necessarily mean that the heat exchangers 12, 16, 20 are numbered in a sequence, which is particularly evident from the examples in FIGS. 2 and 3.

In all embodiments of FIGS. 1 to 3, the first heat exchanger 12 can be a low-temperature cooler, which is connected in particular to a cooling liquid circuit, preferably a cooling water circuit. The second heat exchanger 16 and the third heat exchanger 20 can be designed as a refrigerant condenser or gas cooler, which are arranged in one or the same refrigerant circuit 18. In relation to the circulation direction ZR of refrigerant in the refrigerant circuit 18, the third heat exchanger 20 is arranged in front of, namely upstream of, the second heat exchanger 16. This is particularly evident from the simplified representations of FIGS. 1A, 2A and 3A.

By means of the contour arrows shown in FIGS. 1A and 1B, an air supply device 22 is indicated which is designed to supply air, in particular ambient air, to the first heat exchanger 12, to the second heat exchanger 16 and to the third heat exchanger 20. The second heat exchanger 16 and the third heat exchanger 20 are arranged in series with respect to a main flow direction HS of air present in the air supply device. The same contour arrows are also shown in FIGS. 2A and 3A, respectively. Air supply can be passive via the external air stream and/or active via at least one fan, which is not shown here.

FIG. 1B shows an example in which the three heat exchangers 12, 16, 20 are essentially of the same size with respect to their inflow surface. In other words, the base surfaces of the heat exchangers 12, 16, 20, shown here in simplified form as rectangles, overlap essentially completely.

FIG. 1C shows an example in which the first heat exchanger 12 (low-temperature cooler) has a smaller base surface than the other two heat exchangers 16, 20 (gas cooler and refrigerant condenser, respectively). The second and third heat exchangers 16, 20 have essentially the same base surface. The first heat exchanger 12 is arranged offset with respect to the second heat exchanger 16. In particular, a gap 24 remains beneath the first heat exchanger 12, through which a partial volume of air can flow directly to the second heat exchanger 16 without prior heating in the first heat exchanger 12. This can improve the cooling performance overall, but especially for the second and/or third heat exchangers 16 and/or 20 connected downstream of the first heat exchanger 12 on the air side.

FIG. 1D shows an example in which the first heat exchanger 12 and the second heat exchanger 16 have a smaller base surface than the third heat exchanger 20. In this example, the first heat exchanger 12 and the second heat exchanger 16 are arranged one above the other and on the air side before the third heat exchanger 20.

FIG. 1E shows an example in which the first heat exchanger 12 has a smaller base surface than the second heat exchanger 16. The second heat exchanger 16, in turn, has a smaller base surface than the third heat exchanger 20. The three heat exchangers 12, 16, 20 are arranged relative to one another in such a way that there is a respective partial overlap of the base surfaces. A gap 24 remains below the first heat exchanger 12 and a gap 26 remains below the second heat exchanger 16 through which a partial volume of air can flow directly to the second heat exchanger 16 or the third heat exchanger 20. This can improve the overall cooling performance.

The vertical arrangement of the heat exchangers also depends on how the respective medium flows through them internally. If the flow through them occurs from top to bottom, the arrangement shown in FIG. 1E is advantageous. However, if in at least one of the heat exchangers 12, 16, 20 the flow should occur differently, e.g. from bottom to top, the arrangement of the heat exchangers relative to each other or their optimal position in the cooler package arrangement, especially in the case of different dimensions, must be adjusted accordingly for the best possible cooling result.

Likewise, it is not excluded to make the third heat exchanger 20 smaller than the two upstream heat exchangers 12, 16, so that it is always completely or partially overlapped by them, which is not shown in more detail here.

With reference to the circulation direction ZR of refrigerant in the refrigerant circuit 18 shown in FIG. 1A and to the circulation direction ZRK of coolant in the coolant circuit 14, it is pointed out that the three heat exchangers 12, 16, 20 are arranged relative to one another in such a way that a respective outlet flow of coolant or refrigerant can either be freely exposed to air flow or is arranged behind the outlet flow of the adjacent heat exchanger with respect to the main flow direction HS of air.

For all heat exchangers 12, 16, 20, it is to be noted that, in the case of a smaller base surface, they can optionally have a greater depth (through which air flows) in order to at least partially compensate for the reduced base surface in terms of cooling capacity.

From the examples in FIG. 1, it is generally apparent that the first heat exchanger 12 is arranged in series with at least one of the other two heat exchangers 16, 20 with respect to the main flow direction HS of air. Furthermore, the examples of FIGS. 1B, 1C and 1E show the following order: first heat exchanger 12 before the second heat exchanger 16 before the third heat exchanger 20, which can be referred to as configuration I.

FIG. 2A shows a schematic and simplified representation of cooler package arrangement 10 for a motor vehicle powered by an internal combustion engine or at least partially electrically, not shown here. The cooler package arrangement comprises a first heat exchanger 12, which is fluidically connected to a coolant circuit 14 of the motor vehicle. Furthermore, the cooler package arrangement 10 has a second heat exchanger 16, which is fluidically connected to a refrigerant circuit 18 of the motor vehicle. The cooler package arrangement 10 comprises a third heat exchanger 20, which is also fluidically connected to the refrigerant circuit 18 of the motor vehicle.

From the examples in FIG. 2, it is generally apparent that the first heat exchanger 12 is arranged in series with at least one of the other two heat exchangers 16, 20 with respect to the main flow direction HS of air. Furthermore, the examples of FIGS. 2B, 2C and 2D show the following order: second heat exchanger 16 before the first heat exchanger 12 before the third heat exchanger 20, which can be referred to as configuration II.

FIG. 2B shows an example in which the three heat exchangers 12, 16, 20 are essentially of the same size with respect to their inflow surface. In other words, the base surfaces of the heat exchangers 12, 16, 20, shown here in simplified form as rectangles, overlap essentially completely.

FIG. 2C shows an example in which the second heat exchanger 16 (second gas cooler or refrigerant condenser) has a smaller base surface than the other two heat exchangers 12, 20 (low-temperature cooler and gas cooler or refrigerant condenser). The first and third heat exchangers 12, 20 have essentially the same base surface. The second heat exchanger 16 is arranged offset with respect to the first heat exchanger 12. In particular, a gap 24 remains below the second heat exchanger 16, through which a partial volume of air can flow directly to the first heat exchanger 12 without prior heating in the second heat exchanger 16. This can improve the overall cooling performance.

FIG. 2D shows an example in which the second heat exchanger 16 has a smaller base surface than the first heat exchanger 12. The first heat exchanger 12, in turn, has a smaller base surface than the third heat exchanger 20. The three heat exchangers 12, 16, 20 are arranged relative to one another in such a way that there is a partial overlap of the base surfaces. A gap 24 remains below the second heat exchanger 16 and a gap 26 remains below the first heat exchanger 12 through which a partial volume of air can flow directly to the first heat exchanger 12 or the third heat exchanger 20. This can improve the overall cooling performance.

Depending on the position of the outlet flow of a medium at a heat exchanger, a gap 24 can, for example, also remain free above a further heat exchanger connected downstream of the second heat exchanger 16, such as the first heat exchanger 12, and can be directly flowed through by a partial volume of unconditioned (ambient) air.

FIG. 3 shows a schematic and simplified representation of cooler package arrangement 10 for a motor vehicle powered by an internal combustion engine or at least partially electrically not shown here. The cooler package arrangement comprises a first heat exchanger 12, which is fluidically connected to a coolant circuit 14 of the motor vehicle. Furthermore, the cooler package arrangement 10 has a second heat exchanger 16, which is fluidically connected to a refrigerant circuit 18 of the motor vehicle. The cooler package arrangement 10 comprises a third heat exchanger 20, which is also fluidically connected to the refrigerant circuit 18 of the motor vehicle.

From the examples in FIG. 3, it is generally apparent that the first heat exchanger 12 is arranged in series with at least one of the other two heat exchangers 16, 20 with respect to the main flow direction HS of air. Furthermore, the examples of FIGS. 3B, 3C, 3D and 3E show the following order: second heat exchanger 16 before the third heat exchanger 20 before the first heat exchanger 12, which can be referred to as configuration III.

FIG. 3B shows an example in which the three heat exchangers 12, 16, 20 are essentially of the same size. In other words, the base surfaces of the heat exchangers 12, 16, 20, shown here in simplified form as rectangles, overlap essentially completely.

FIG. 3C shows an example in which the first heat exchanger 12 (low-temperature cooler) has a maximum base surface. The second and third heat exchangers 16, 20 have essentially the same base surface. In this configuration, the second heat exchanger 16 is fully or 100% exposed to (ambient) air. Below the second and third heat exchangers 16, 20, which in turn can be dimensioned differently or of the same size with respect to the inflow surface, a respective intermediate space 24, 26 is formed so that air can flow directly to the first heat exchanger 12.

FIG. 3D shows an example in which the first heat exchanger 12 (low-temperature cooler) has a maximum base surface. The second and third heat exchangers 16, 20 have different base surfaces, wherein the base surface of the second heat exchanger 16 can be larger or equal to the base surface of the third heat exchanger 20. A gap 24 is formed above the second heat exchanger 16 so that air can flow directly to the third heat exchanger 20. A gap 26 is formed below the third heat exchanger so that air can flow directly from the second heat exchanger 16 to the first heat exchanger 12. In this configuration, the second heat exchanger 16 is fully or 100% exposed to (ambient) air. Especially in this application example, an outlet flow of the medium in the third heat exchanger 20 can optionally be located at the top.

FIG. 3E shows an example in which the first heat exchanger 12 (low-temperature cooler) has a maximum base surface. The second and third heat exchangers 16, 20 have different base surfaces, wherein the base surface of the second heat exchanger 16 is larger than the base surface of the third heat exchanger 20. In this configuration, the second heat exchanger 16 is fully or 100% exposed to (ambient) air. A respective gap 24, 26 is formed below the second and third heat exchangers 16, 20 so that air can flow directly to the first heat exchanger 12.

Considering all the examples of different configurations of the cooler package arrangement 10 described above with reference to FIGS. 1 to 3, the following features may also apply to individual, several or all heat exchangers 12, 16, 20 of the corresponding cooler package arrangement.

All heat exchangers can have inflow surfaces of equal size. Furthermore, at least one of the heat exchangers may differ in its inflow surface from the remaining ones. Ultimately, all heat exchangers can have different inflow surfaces

Relative to the main flow direction HS of air, the last heat exchanger has the largest base surface. In particular, the base surface of the last heat exchanger is larger than at least one base surface of one of the heat exchangers arranged in front of it.

In the described cooler package arrangements 10, each heat exchanger 12, 16, 20 can be designed such that it is formed with at least one coolant inflow or refrigerant inflow. In particular, the heat exchangers can also be designed with multiple inflows and each with its own outlet flow.

In the various cooler package arrangements 10, with respect to the main flow direction HS of air, the last heat exchanger can have an outlet flow that is freely exposed to air flow. This applies in particular to the examples in FIGS. 1E, 2D, 3C and 3E.

In the various cooling package arrangements 10, two heat exchangers which at least partially overlap and are arranged one after the other with respect to the main flow direction HS of air can be arranged in such a way that their respective outlet flows essentially overlap. This applies to all examples shown due to the circulation direction ZR (refrigerant circuit 18) and ZRK (coolant circuit 14) shown in simplified form in FIGS. 1A, 2A and 3A.

In the cooler package arrangements 10 of FIGS. 2 and 3, the second heat exchanger 16 and the third heat exchanger 20, both of which are in fluid communication with the refrigerant circuit 18, are arranged such that one of the two heat exchangers 16 forms the frontmost heat exchanger, which is essentially fully exposed and is the first to be exposed to (ambient) air, and the other heat exchanger 20 is essentially overlapped by the frontmost heat exchanger 16.

All heat exchangers 12, 16, 20 can be of the same or different dimensions with respect to their respective base surface. In addition or as an alternative to a change in the base surfaces, the heat exchangers 12, 16, 20 can also have the same or different depths. In particular, a heat exchanger with a smaller base surface can have a greater depth, so that a reduced cooling capacity of the corresponding heat exchanger due to a reduction in base surface can be at least partially compensated.

Likewise, for each of the described embodiments of the cooler package arrangement 10, at least one fan device can be provided, which has a pushing or sucking effect with respect to all heat exchangers 12, 16, 20 in order to allow air to flow through the cooler package arrangement. In addition or as an alternative, it is also conceivable to arrange a (possibly additional) fan device between two adjacent heat exchangers.

The above exemplary embodiments relate in particular to heat exchangers each with substantially horizontal fluid guidance, in particular in the second and third heat exchangers 16, 20 (gas cooler and refrigerant condenser, respectively). However, the concepts presented here can also be used for heat exchangers with essentially vertical fluid flow, provided they are adapted accordingly. In this case, gaps 24, 26 shown as examples in FIGS. 1 to 3 can then not be arranged above or below a respective heat exchanger, but ideally to the left or right of a respective heat exchanger. Furthermore, it is also possible to combine heat exchangers with different fluid guides and to position them optimally relative to each other.

In addition, it should be noted that in addition to the above-mentioned embodiment of a horizontal fluid guide in all heat exchangers and the above-described case of a vertical fluid guide in all heat exchangers, combinations are also possible. In particular, the fluid flow in at least one heat exchanger (vertical or horizontal) can differ from the fluid flow in the remaining heat exchangers. This enables a mixed installation of horizontal and vertical fluid flow. Particularly in condensers and/or gas coolers, preferably in air heat pump applications, vertical fluid flow can be used to support fluid drainage at or in the respective heat exchanger. Furthermore, components or heat exchangers can also be used which can intrinsically have a so-called mixed fluid flow with horizontal and vertical parts of the fluid flow.

1-11. (canceled)

12. A cooler package arrangement for a motor vehicle powered by an internal combustion engine or at least partially electrically, comprising:
a first heat exchanger which is fluidically connected to a coolant circuit of the motor vehicle;
a second heat exchanger which is fluidically connected to a refrigerant circuit of the motor vehicle;
a third heat exchanger which is fluidically connected to a refrigerant circuit of the motor vehicle; and
an air supply device which is designed to supply air, in particular ambient air, to the first heat exchanger, to the second heat exchanger and to the third heat exchanger,
wherein the second heat exchanger and the third heat exchanger are arranged in series with one another with respect to a main flow direction of air present in the air supply device.

13. The cooler package arrangement according to claim 12, wherein the first heat exchanger is arranged in series with at least one of the other two heat exchangers with respect to the main flow direction of air.

14. The cooler package arrangement according to claim 12, wherein the first heat exchanger is a low-temperature cooler and wherein the second heat exchanger and the third heat exchanger are designed as a refrigerant condenser and a gas cooler, respectively.

15. The cooler package arrangement according to claim 12, wherein the order of the heat exchangers with respect to the main flow direction of air is as follows:
first heat exchanger before second heat exchanger before third heat exchanger; or
second heat exchanger before first heat exchanger before third heat exchanger (20); or
second heat exchanger before third heat exchanger before first heat exchanger.

16. The cooler package arrangement according to claim 12, wherein each heat exchanger has a base surface facing the main flow direction of air, wherein
the base surfaces of all heat exchangers are essentially the same size; or
each heat exchanger has a base surface that differs from at least one base surface of one of the other heat exchangers.

17. The cooler package arrangement according to claim 16, wherein, based on the main flow direction of air, the last heat exchanger has the largest base surface, which is in particular larger than at least one base surface of one of the heat exchangers arranged in front of it.

18. The cooler package arrangement according to claim 12, wherein each heat exchanger is designed such that it is formed with at least one coolant inflow or refrigerant inflow, in particular in a multi-flow design with a respective outlet flow.

19. The cooler package arrangement according to claim 18, wherein, with respect to the main flow direction of air, at least the last heat exchanger has an outlet flow which is freely exposed to air flow.

20. The cooler package arrangement according to claim 17, wherein two heat exchangers which at least partially overlap and are arranged one after the other with respect to the main flow direction of air are arranged in such a way that their respective outlet flows essentially overlap.

21. The cooler package arrangement according to claim 18, wherein the second heat exchanger and the third heat exchanger, both of which are fluidically connected to the refrigerant circuit, can be arranged such that one of the two heat exchangers forms the frontmost heat exchanger, which is essentially fully exposed to air, and the other of the two heat exchangers is essentially overlapped by the frontmost heat exchanger.

22. A motor vehicle with a drive provided by an internal combustion engine or which is at least partially electric and with a cooler package arrangement according to claim 12.

23. The cooler package arrangement according to claim 12, wherein the first heat exchanger is a low-temperature cooler and wherein the second heat exchanger and the third heat exchanger are designed as a refrigerant condenser and a gas cooler, respectively.

24. The cooler package arrangement according to claim 13, wherein the order of the heat exchangers with respect to the main flow direction of air is as follows:
first heat exchanger before second heat exchanger before third heat exchanger; or
second heat exchanger before first heat exchanger before third heat exchanger; or
second heat exchanger before third heat exchanger before first heat exchanger.

25. The cooler package arrangement according to claim 14, wherein the order of the heat exchangers with respect to the main flow direction of air is as follows:
first heat exchanger before second heat exchanger before third heat exchanger; or
second heat exchanger before first heat exchanger before third heat exchanger; or
second heat exchanger before third heat exchanger before first heat exchanger.

26. The cooler package arrangement according to claim 13, wherein each heat exchanger has a base surface facing the main flow direction of air, wherein
the base surfaces of all heat exchangers are essentially the same size; or
each heat exchanger has a base surface that differs from at least one base surface of one of the other heat exchangers.

27. The cooler package arrangement according to claim 14, wherein each heat exchanger has a base surface facing the main flow direction of air, wherein
the base surfaces of all heat exchangers are essentially the same size; or
each heat exchanger has a base surface that differs from at least one base surface of one of the other heat exchangers.

28. The cooler package arrangement according to claim 15, wherein each heat exchanger has a base surface facing the main flow direction of air, wherein
the base surfaces of all heat exchangers are essentially the same size; or
each heat exchanger has a base surface that differs from at least one base surface of one of the other heat exchangers.

29. The cooler package arrangement according to claim 13, wherein each heat exchanger is designed such that it is formed with at least one coolant inflow or refrigerant inflow, in particular in a multi-flow design with a respective outlet flow.

30. The cooler package arrangement according to claim 14, wherein each heat exchanger is designed such that it is formed with at least one coolant inflow or refrigerant inflow, in particular in a multi-flow design with a respective outlet flow.

31. The cooler package arrangement according to claim 15, wherein each heat exchanger is designed such that it is formed with at least one coolant inflow or refrigerant inflow, in particular in a multi-flow design with a respective outlet flow.
